(19) United States
(12) Patent Application Publication
(10) Pub. No.: US 2014/0167467 A1
(43) Pub. Date: Jun. 19, 2014

(54) VEHICLE SEAT

(71) Applicant: GM GLOBAL TECHNOLOGY OPERATIONS LLC, Detroit, MI (US)

(72) Inventors: Martin Petermann, Elz (DE); Hardy Huck, Ruesselsheim (DE)

(73) Assignee: GM GLOBAL TECHNOLOGY OPERATIONS LLC, Detroit, MI (US)

(21) Appl. No.: 14/107,461

(22) Filed: Dec. 16, 2013

(30) Foreign Application Priority Data
Dec. 14, 2012 (DE) 10 2012 024 429.0

(51) Int. Cl. B60N 2/07

(52) U.S. Cl. CPC B60N 2/0735
USPC 297/344.1

(57) ABSTRACT

A vehicle seat is provided that is displaceable to and fro in longitudinal direction of a motor vehicle, with a first guide element, which is arranged at the bottom of the vehicle seat, and with a second guide element in engagement with the first guide element, which second guide element is arranged on a floor of the motor vehicle. A third guide element is likewise arranged on the vehicle seat, and a fourth guide element, in engagement with the third guide element, is arranged on a center tunnel.

### CROSS-REFERENCE TO RELATED APPLICATION

This application claims priority to German Patent Application No. 10 2012 024 429.0, filed Dec. 14, 2012, which is incorporated herein by reference in its entirety.

### TECHNICAL FIELD

The technical field generally relates to a vehicle seat, which is displaceable to and fro in longitudinal direction of a motor vehicle, with a first guide element, which is arranged at the bottom of the vehicle seat, and with a second guide element which is arranged on a floor of the motor vehicle.

### BACKGROUND

Vehicle seats which are displaceable to and fro are known from the prior art, which are guided on guide rails in the region the edges of the vehicle seat. Such vehicle seats sometimes appear heavy and cumbersome.

In view of the foregoing, at least one object is to provide a vehicle seat that has the visual effect of being light and free-floating. In addition, objects, desirable features and characteristics will become apparent from the subsequent summary and detailed description, and the appended claims, taken in conjunction with the accompanying drawings and this background.

### SUMMARY

A vehicle seat is provided that is displaceable to and fro in longitudinal direction of a motor vehicle, with a first guide element, which is arranged at the bottom of the vehicle seat, and with a second guide element, in engagement with the first guide element, which second guide element is arranged on a floor of the motor vehicle. A third guide element is likewise arranged on the vehicle seat and a fourth guide element, in engagement with the third guide element, is arranged on a center tunnel. The vehicle seat therefore has the visual effect of being light and free-floating. It conveys a greater sense of space in the motor vehicle. The third and fourth guide element guarantee for the vehicle seat an increased stability.

The first guide element and the second guide element can have a particular distance from an edge of the vehicle seat, so that they are not visible for a person when getting into the motor vehicle. Thereby, the impression of the free-floating vehicle seat is intensified. In an embodiment, the first guide element can be arranged on the vehicle seat on its center axis running parallel to the longitudinal direction of the vehicle. In this way, it is ensured that the first and second guide element are not noticed by the person when getting into the motor vehicle.

Likewise in order to ensure that the first and second guide element are not noticed by the person when getting into the motor vehicle, the first guide element can be arranged between the center axis of the vehicle seat and the center tunnel, i.e., eccentrically. This arrangement can be especially expedient when the distance between the floor of the motor vehicle and the vehicle seat is relatively great.

The third guide element can be arranged laterally on the vehicle seat in the vicinity of the center tunnel. In this way, it is situated in the immediate vicinity of the fourth guide element, which is connected with the third guide element.

The first guide element can be a runner extending in longitudinal direction of the vehicle, or a column, and the second guide element can be a guide rail in which the first guide element is guided. The runner guarantees a particularly high degree of stability, whereas the column has the visual effect of being particularly light. For the same reason, the third guide element can likewise be a runner extending in longitudinal direction of the vehicle, or a bolt, and the fourth guide element can be a guide rail in which the third guide element is guided. In an embodiment, the fourth guide element can be a groove that is included into the center tunnel, and the third guide element can be a bolt engaging into the groove.

In order to enhance the overall appearance of the vehicle seat still further, a blind can be arranged on the guide element, which is constructed as a runner or as a column, for covering the guide element which is constructed as a guide rail. On displacement of the vehicle seat, the blind is therefore also displaced along the guide rail, so that it covers the guide rail in every position of the vehicle seat.

Expediently, the guide element, which is constructed as a runner or as a column, can be aligned parallel to the vertical axis of the vehicle. So that the guide element, which is constructed as a runner or as a column, can also receive forces which act in the transverse direction of the vehicle, the first guide element and the second guide element can form an angle of between approximately 0° and approximately 90° with the vertical axis of the vehicle.

Preferably, the vehicle seat is a front seat. However, the vehicle seat according to the invention can also be arranged in a van in a rear row of seats.

A motor vehicle is also provide that has the vehicle seat according to the described embodiments.

### BRIEF DESCRIPTION OF THE DRAWINGS

The present invention will hereinafter be described in conjunction with the following drawing figures, wherein like numerals denote like elements, and:

FIG. 1 is a view from the front onto a first embodiment of the vehicle seat;

FIG. 2 is a view from the front onto a second embodiment of the vehicle seat;

FIG. 3 is a view from above onto a third embodiment of the vehicle seat;

FIG. 4 is a view from above onto a fourth embodiment of the vehicle seat;

FIG. 5 is a perspective view onto a fifth embodiment of the vehicle seat; and

FIG. 6 is a perspective view onto a sixth embodiment of the vehicle seat.

### DETAILED DESCRIPTION

The following detailed description is merely exemplary in nature and is not intended to limit application and uses. Furthermore, there is no intention to be bound by any theory presented in the preceding background or summary or the following detailed description.

FIG. 1 shows a vehicle seat 10 with a first guide element 11, which is arranged at the bottom of the vehicle seat 10. The guide element 11 engages into a second guide element 12, which is constructed as a guide rail and is arranged on a floor 13. A third guide element 14 is arranged at the edge of the vehicle seat 10 and engages into a guide element 15, which is likewise constructed as a guide rail. The guide element 15 is arranged on a center tunnel 16. The guide element 11 is arranged on a center axis running parallel to the longitudinal direction of the vehicle. The guide elements 11 and 14 are therefore mounted fixedly to the vehicle seat. On displacement of the vehicle seat 10, they also move along the guide elements 12 and 15.

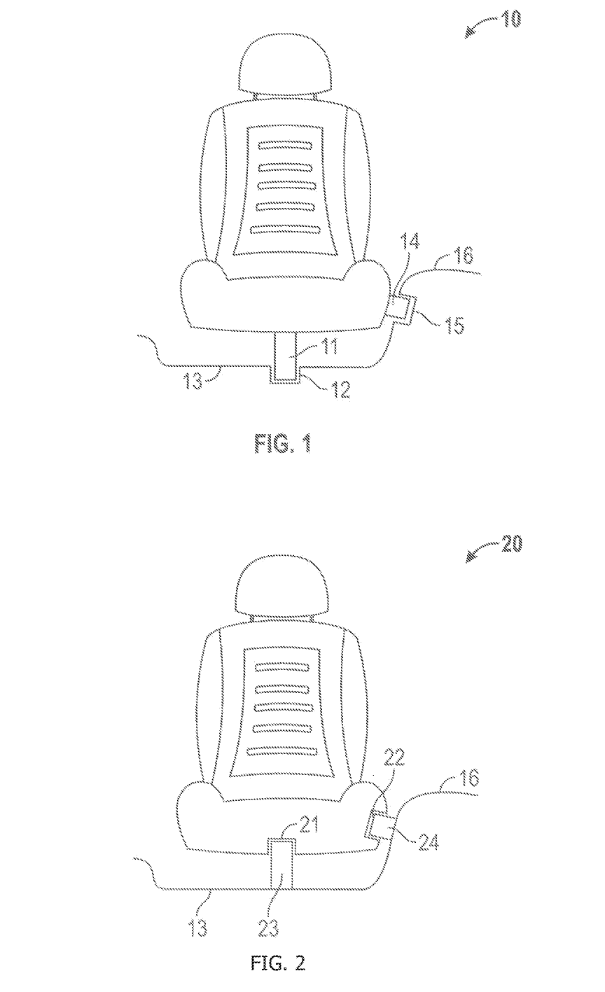

In a vehicle seat 20 (see FIG. 2) guide elements 21 and 22, constructed as guide rails, are mounted on the vehicle seat. Engaged into them are guide elements 23 and 24, which are arranged on the floor 13 and on the center tunnel 16. The guide elements 23 and 24 are therefore fixed with respect to the motor vehicle. On displacing of the vehicle seat 20, therefore only the vehicle seat is displaced, whereas the guide elements 23 and 24 maintain their position relative to the motor vehicle.

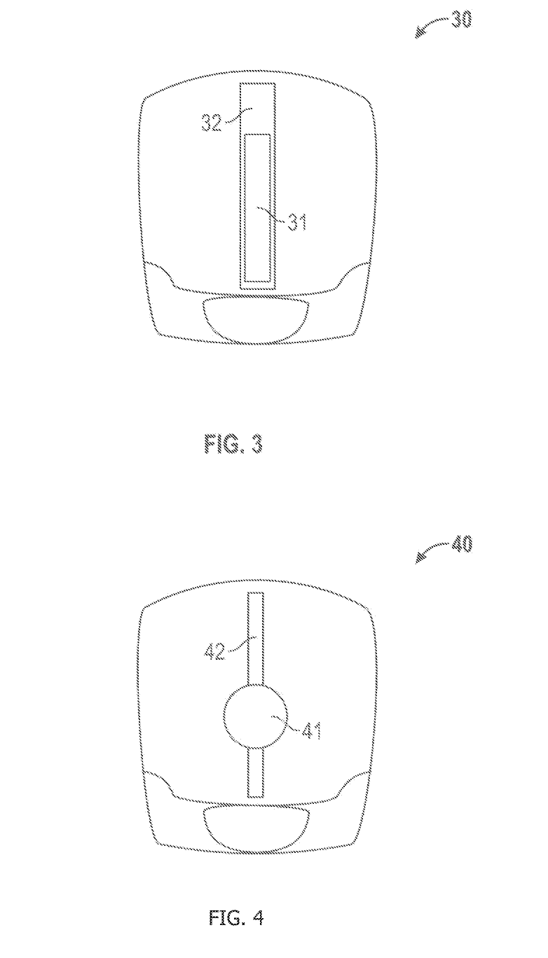

FIG. 3 shows a vehicle seat 30 which rests on a guide element 31 constructed as a runner. The guide element 31 is fastened to the vehicle seat 30, where a guide element 32 in the form of a guide rail is arranged on the floor of the motor vehicle.

FIG. 4 shows a vehicle seat 40, which is mounted on a guide element 41 which is constructed as a column which is connected with the vehicle seat. A guide element 42 is likewise embodied in the form of a guide rail.

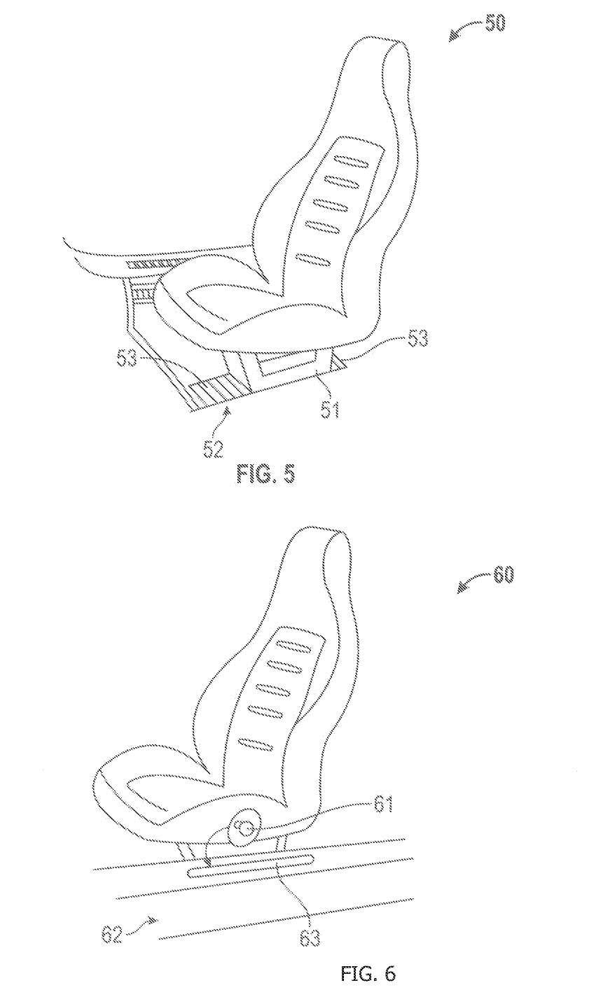

On a vehicle seat 50 a guide element 51, likewise constructed as a runner, is fastened, which guide element can be displaced in a guide element 52, constructed as a guide rail, together with the vehicle seat 50 (see FIG. 5). A blind 53 covers the guide element 52 in front of and behind the guide element 51, so that the guide element 52 cannot be noticed at all.

In another embodiment, a vehicle seat 60 is guided inter alia with a guide element 61, embodied as a bolt, along a guide element 63, which is included as a groove in a center tunnel 62 (see FIG. 6). The guide element 61 is fixed with respect to the vehicle seat 60.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1. A vehicle seat that is displaceable to and fro in a longitudinal direction of a motor vehicle, comprising:
a first guide element arranged at a bottom of the vehicle seat;
a second guide element that is configured to engage the first guide element and arranged on a floor of the motor vehicle;
a third guide element arranged on the bottom of the vehicle seat; and
a fourth guide element that is configured to engage with the third guide element and arranged on a center tunnel.

2. The vehicle seat according to claim 1, wherein the first guide element and the second guide element have a distance from an edge of the vehicle seat that provides limited visibility of the first guide element and the second guide element from an entrance view into the motor vehicle.

3. The vehicle seat according to claim 1, wherein the first guide element is arranged on the vehicle seat on a center axis running parallel to the longitudinal direction of the vehicle.

4. The vehicle seat according to claim 2, wherein the first guide element is arranged between the center axis of the vehicle seat and the center tunnel.

5. The vehicle seat according to claim 1, wherein the third guide element is arranged laterally on the vehicle seat in a region of the center tunnel.

6. The vehicle seat according to claim 1, wherein the first guide element is a runner extending in the longitudinal direction of the vehicle and the second guide element is a guide rail that is configured to guide the first guide element.

7. The vehicle seat according to claim 6, wherein the third guide element is a second runner extending in the longitudinal direction of the vehicle and the fourth guide element is a second guide rail that is configured to guide the third guide element.

8. The vehicle seat according to claim 7, wherein the fourth guide element is a groove included into the center tunnel, and the third guide element is a bolt engaging into the groove.

9. The vehicle seat according to claim 6, wherein a blind is arranged for covering the guide element that is constructed as a guide rail and constructed as a runner.

10. The vehicle seat according to claim 9, wherein the guide element is aligned parallel to the vertical axis of the vehicle.

11. The vehicle seat according to claim 9, wherein the first guide element forms an angle of between approximately 0° and approximately 90° with a vertical axis of the vehicle.

12. The vehicle seat according to claim 1, wherein the vehicle seat is a front seat.

13. (canceled)
